(19) United States
(12) Patent Application Publication
(10) Pub. No.: US 2003/0135842 A1
(43) Pub. Date: Jul. 17, 2003

(54) Software development tool for embedded computer systems

(76) Inventors: Jan-Erik Frey, Vasteras (SE); Robert Majanen, Vasteras (SE); Anders Risberg, Linkoping (SE); Anders Rosvall, Vasteras (SE)

Correspondence Address: YOUNG & THOMPSON, 745 SOUTH 23RD STREET 2ND FLOOR, ARLINGTON, VA, 22202

(21) Appl. No.: 10/046,157

(22) Filed: Jan. 16, 2002

(51) Int. Cl. G06F 9/44

(52) U.S. Cl. 717/121

(57) ABSTRACT

The invention concerns a software development tool for embedded computer systems, and is based on a repository of configurable, pre-programmed software components, together with associated tools for user selection and configuration of the components and a code generator for extracting relevant source code based on the configuration settings. Each software component, called embedded system infrastructure component (ESIC), is a self-contained object comprising a modular code base and associated configuration structure related to an infrastructure function in a hardware-independent, non-operating-system software infrastructure for an embedded computer system. For each ESIC, the configuration tool enables user configuration of the infrastructure function based on the configuration structure of the ESIC to match the requirements of the target application. For each ESIC, the code generator utilizes the configuration settings to extract source code for the infrastructure as a subset of the modular code base. This approach provides fast, efficient and flexible development of embedded system software infrastructures.

### TECHNICAL FIELD OF THE INVENTION

The present invention generally relates to embedded computer systems and more particularly to a software development tool for such systems.

### BACKGROUND OF THE INVENTION

An embedded computer system can be seen as a dedicated computer system providing control and computation as part of a more complete technical system. Embedded computer systems do not generally posses the same features as personal computers (PCs). As the name indicates, they are embedded in a larger system and normally not seen by the user. For example, embedded computer systems can be found in mobile telephones, washing machines, automatic cash dispensers, elevators and industrial production lines. They often have demanding real-time requirements, which means they have to be able to perform their functions within a certain time-period.

In addition to real-time requirements, embedded systems also have much higher demands on reliability than “traditional”, PC-based, computer systems. Personal computers today often experience software problems, and it is not uncommon for a PC to crash occasionally. However, a washing machine or elevator that stops working all of sudden due to an unreliable embedded computer system is generally not acceptable. What makes the situation worse is that there are much more washing machines out there than PCs, and the software or hardware of a washing machine cannot be upgraded easily. This means that a faulty embedded system often has to be withdrawn and replaced by a completely new system, with severe economical consequences as a result.

On top of all these requirements, embedded systems are also very cost sensitive. This normally means that embedded systems are highly resource-constrained computer systems with limited resources in terms of both CPU power and memory. In fact, embedded computer systems are often based on proprietary and highly optimized hardware with little or no possibilities for future expansion.

FIG. 1 illustrates an embedded computer system from a hierarchical point of view. At the bottom we normally have proprietary and highly optimized hardware such as a memory 20 and peripherals 30 connected to a microcontroller/microprocessor core 40. The microcontroller core 40 may for example be implemented as a microcontroller unit (MCU), a microprocessor unit (MPU) or a digital signal processor (DSP). On top of the hardware, various sorts of drivers that provide a software interface towards the hardware can be found. This layer 50, also known as the Hardware Abstraction Layer (HAL), is normally very low-level and hardware-specific. Since most embedded system have real-time demands, they usually run a real-time operating system (RTOS) 60 on top of the hardware. Most commercial RTOS systems are large and pre-emptive, and thus quite expensive. This situation has driven many manufacturers to develop their own, in-house, RTOS. In fact more than 50% of all embedded systems run an in-house RTOS. On top of the RTOS 60, we find a large common base of software functionality, which is called the embedded system software infrastructure 70. The software infrastructure 70 is a set of functions common to a large group of application domains. At the top layer, we find the added-value application 80.

As shown in FIG. 1, the software infrastructure 70 is the only portion of the embedded system that is generic. The hardware side of an embedded system is always extremely application-dependent or rather optimized for the particular application in question. The application obviously is not generic. Even two similar applications (from a functional perspective) may be realized in completely different ways.

FIG. 2 illustrates different categories of infrastructure functions in an exemplary software infrastructure. The software infrastructure 70 includes communication protocols 72, a low-level interface 74 to the hardware, general low-level algorithms 76 and general high-level algorithms 78. Examples of specific functions within the different categories include Bluetooth, HDLC, PPP and TCP/IP for the communication protocols 72, flash programming for the low-level interface 74, data structures and memory allocation for the low-level algorithms 76 and database packages, encryption, file systems and web servers for the high-level algorithms.

Although the functionality of the infrastructure is generic, the requirements on the infrastructure differ significantly from application to application. Each application has different requirements on behavior, memory, execution speed, and the interfaces towards the hardware/application. This has made it difficult to standardize these infrastructure functions. In fact, more than ⅔ of the software development is spent on realizing these functions. This means that on average, companies only spend ⅓ of their software development on the value-added application of their products. With the demand for increased functionality in embedded systems, together with a generally shorter time-to-market, embedded system developers are apparently faced with an extremely difficult and sometimes even impossible task.

### RELATED ART

In the prior art, there have been attempts to facilitate and automate the development of embedded system software, especially on the real-time operating system level and the device driver level of the embedded system.

The Embedded Configurable Operating System (eCos) is a royalty-free, open-source, real-time kernel, targeted at high-performance embedded systems. The eCos operating system is designed as a configurable architecture. The building blocks of an eCos configuration are called packages. The eCos system comes with a set of core packages such as the kernel, the C library and math library. Each of these provides a number of configuration options, allowing application developers to build an operating system that matches the requirements of their particular application. The entire eCos kernel can be viewed as one big component, containing tightly linked sub-components for scheduling, exception handling, synchronization primitives, and so on. The synchronization primitives can contain further sub-components for mutexes, semaphores, condition variables, event flags, and so on. The mutex component can contain configuration options for issues like priority inversion support. The eCos Configuration Tool is used to tailor eCos at source level, prior to compilation or assembly, and provides a configuration file and a set of files used to build user applications. The configuration option is the basic unit of configurability. Typically each option corresponds to a single choice that a user can make. For example there is an option to control whether or not assertions are enabled, and the kernel provides an option corresponding to the number of scheduling priority levels in the system. Options can control very small amounts of code such as whether or not the C library's strtok gets inlined. They can also control quite large amounts of code, for example whether or not the printf supports floating point conversions.

Naturally, the open source code of eCos makes it possible for a user to write his/her own packages for use together with the core packages of eCos.

In eCos, configuration dependencies are described via an expression language, which can result in conflicts that have to be resolved manually. Automatic resolution through an inference engine provides suggestions on how to resolve the problem. This could require multiple resolution passes before all conflicts are resolved.

The eCos system generates configuration header files with C preprocessor #defines for each option. It is up to component writers to decide whether to use preprocessor #ifdef statements or language constructs such as if. This approach has several drawbacks. The #ifdef code is very messy and difficult to understand and maintain. It provides a limited facility, e.g. no looping. The C preprocessor is not applicable to languages such as Java.

IAR MakeApp™ of IAR Systems is a family of device driver development tools. It provides an environment for visual design and automatic generation of device drivers. MakeApp generates device drivers based on a graphical configuration of the peripheral modules. A new project is created by selecting the desired microcontroller derivative, bus mode and clock frequency. Configuration of a device driver is accomplished through a set of dialogs. Based on the configuration, MakeApp generates source code in the “C” language. The set of device driver files and functions to be generated can be selected individually in order to save space in the target system. As device drivers are highly target dependent, MakeApp takes advantage of the selected compiler environment and makes use of features such as interrupt #pragmas, inline assembly (where needed) or intrinsic functions.

IAR Systems also offers a Bluetooth protocol stack generator based on IAR MakeApp™ technology. It is possible to configure the stack on a high abstraction level, and the code generator then automatically generates a tailor made stack implementation in source code.

The international patent application WO 01/65364 describes a system and method aimed at facilitating cross-platform software development. The developer receives an input file (INF) and generates a formatted data file (FDF) as a function of the INF file. The FDF file contains the data of the INF stored in a predetermined format compatible between multiple platforms. The developer then generates a common generation file (CGF), using e.g. C, which is capable of creating an output file compatible with each platform. The FDF file is modified via a Graphical User Interface (GUI) or Command Line Interface (CLI) of the target platform, in order to create a modified formatted data file (MFDF). The MFDF file is generated by the CGF file, i.e. the data of the FDF file is extracted by the CGF file and the modifications provided by the user are stored by the CGF file according to the same predetermined format of the FDF. Finally the CGF file is compiled with the MFDF file to generate the predefined output file for the corresponding platform. As input, the CGF file accepts data saved in structured form, such as the name of the MFDF, its structure and a desired type of computing platform.

### SUMMARY OF THE INVENTION

It is a general object of the present invention to provide a software development tool for embedded computer systems that supports fast, efficient and flexible development of embedded system software infrastructures.

It is particularly desirable to reduce the development time for the infrastructure software, thus reducing the time-to-market of the complete embedded system or alternatively leaving more time for development of the added-value application software.

It is also desirable to provide a software development tool that generates optimized and compact infrastructure source code, tailored to the specific requirements of the target application (keeping in mind that the requirements may differ significantly from application to application).

It is particularly beneficial to provide a fine-grained control over the embedded system infrastructure software with regard to resulting functionality, implementation and performance trade-offs.

These and other objects are met by the invention as defined by the accompanying patent claims.

The software development tool according to the invention is based on a repository of configurable, pre-programmed infrastructure software components, together with associated tools for user selection and user configuration of the infrastructure software components and a code generator for extracting relevant source code based on the user-selected configuration settings of the selected software components.

Each pre-programmed software component, generally referred to as an embedded system infrastructure component (ESIC), is a self-contained object that comprises an underlying modular code base and associated configuration structure related to a specific infrastructure function in a hardware-independent, non-operating-system software infrastructure for an embedded computer system. Examples of ESIC infrastructure functions include an embedded web-server, a TCP/IP stack, a file system and a sorting algorithm. For each ESIC selected from the repository, the configuration tool enables user configuration of the corresponding infrastructure function based on the underlying configuration structure of the ESIC in order to match the requirements of the target application. For each selected ESIC, the code generator then utilizes the user-selected configuration settings in order to extract source code for the infrastructure software as a subset of the modular code base of the ESIC.

This approach provides fast, efficient and flexible development of embedded system software infrastructures. The software development tool may be provided with a wide range of ESICs capable of giving a broad spectrum of infrastructure software functions, and the configuration tool enables flexible configuration of the ESICs with regard to resulting functionality, implementations and performance trade-offs. The code generator still provides a very compact source code through a highly modularized code base in combination with the user-selected configuration settings. Only the relevant source code will be extracted from the modular code base in response to selected configuration settings.

The solution according to the invention also allows fast prototyping and implementation of configuration changes. It is very easy for the developer to go back and re-configure ESICs after evaluation until all design requirements are met.

The fact that the ESICs are independent, self-contained objects facilitate the definition, handling and maintenance of the ESICs. Advantageously, the ESICs are defined by means of an extensible description language such as XML (eXtensible Mark-up Language) in order to further facilitate the ESIC definition and to improve the readability of the code.

Preferably, the software development tool also has capabilities for supporting ESIC interaction, including interconnection of ESICs as well as ESIC encapsulation. With regard to ESIC interconnection, the user should be able to select a number of ESICs for interconnection. Conveniently, the code generator then generates separate source code, i.e. glue code, relating to the interconnection of the ESICs based on the configuration settings of the involved ESICs. In the case of ESIC encapsulation, the encapsulated inner ESIC is typically configured by the corresponding outer ESIC via template selection. This means the outer ESIC has a number of predetermined templates for configuring the inner ESIC and one of these templates is selected based on the configuration settings of the outer ESIC.

The configuration tool is preferably adapted for providing direct user feedback on the effects of a configuration setting in terms of resulting code size, execution speed, memory consumption, specific restrictions or performance trade-offs. In combination with the efficient code extraction from the modular code base, this feature may provide certain synergetic effects on the overall code size.

In a preferred embodiment of the invention, an ESIC may have code for multiple implementations of a given sub-function to enable user configuration of the infrastructure function of the ESIC with respect to the type of implementation to be used for the given sub-function.

In order to minimize the integration work for the application programmer, the ESICs may also be provided with configurable interfaces towards underlying low-level functions or hardware on one side and the target application on the other side.

Other advantageous features of the software development tool according to the invention include automatic generation of relevant documentation, ESIC callbacks for enabling temporary application-specific processing, ESIC set-up re-creation based on source code signatures and tamper-verification through the use of source code checksums.

The software infrastructure is a platform of generic infrastructure software functions for embedded computer systems.

The invention offers the following advantages:

Fast, efficient and flexible embedded system software development;

Reduced time-to-market;

Optimized and compact infrastructure source code;

Support for combination and interaction of multiple ESICs to create composite infrastructure functions;

Automatic expert guidance by means of direct user feedback on the effects of configuration settings;

Fine-grained control over the embedded system infrastructure software;

Multiple implementations of sub-functions;

Configurable interfaces towards hardware/low-level functions and application;

Automatic generation of relevant documentation;

Callbacks for application-specific processing;

ESIC set-up re-creation based on source code signatures; and

Tamper-verification through the use of source code checksums.

Other advantages offered by the present invention will be appreciated upon reading of the below description of the embodiments of the invention.

### BRIEF DESCRIPTION OF THE DRAWINGS

The invention, together with further objects and advantages thereof, will be best understood by reference to the following description taken together with the accompanying drawings, in which:

FIG. 1 illustrates an embedded computer system from a hierarchical point of view;

FIG. 2 illustrates different categories of infrastructure functions in an exemplary software infrastructure;

FIG. 3 illustrates a general overview of the embedded system development technology according to a preferred embodiment of the invention;

FIG. 4 illustrates different levels of ESIC configurability according to a preferred embodiment of the invention;

FIG. 5 is a schematic diagram of an exemplary embedded wireless data logger;

FIG. 6 is a schematic diagram illustrating the principal building blocks of an ESIC according to an exemplary embodiment of the invention;

FIG. 7 illustrates an example of a modular code base with multiple implementations;

FIG. 8 illustrates an exemplary configuration structure of an ESIC including configurations, sub-configurations, groups, sub-groups and requirements;

FIG. 9 illustrates an example of the file composition of the code base of an ESIC;

FIG. 10 illustrates the mapping between ESIC configurations and the code blocks that shall be used in the code generation process;

FIG. 11 is a schematic diagram of the ESIC configuration and code generation process according to an exemplary, preferred embodiment of the invention;

FIG. 12 illustrates relevant parts of a screen display of the overall graphical user environment;

FIG. 13 illustrates relevant parts of screen displays used for adding an ESIC from the ESIC repository;

FIG. 14 illustrates the graphical user environment as a configuration page is displayed in the project space;

FIG. 15 is a schematic diagram illustrating how several ESICs interact with each other;

FIG. 16 illustrates the principal concept of generating glue code for interconnecting ESICs;

FIG. 17 illustrates an example of ESIC encapsulation;

FIG. 18 illustrates an example of the various sub-systems of a client-and-server application, and how they communicate with each other;

FIG. 19 illustrates different examples of client-side processing;

FIG. 20 illustrates the code generation process according to a preferred embodiment in greater detail; and

FIGS. 21-23 show different use cases in a client-and-server application.

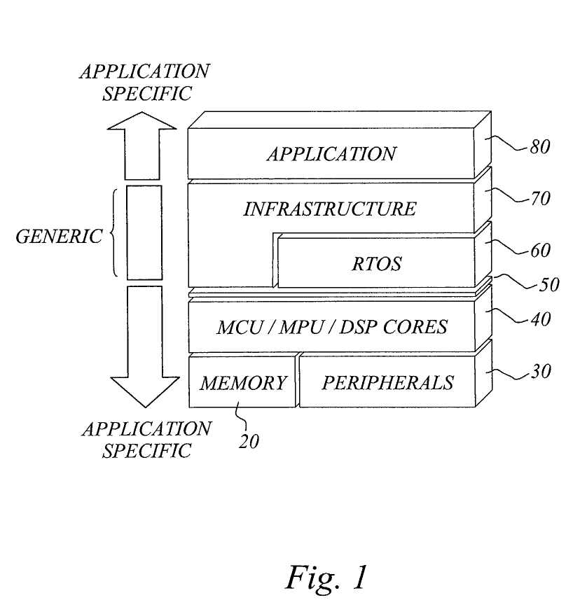

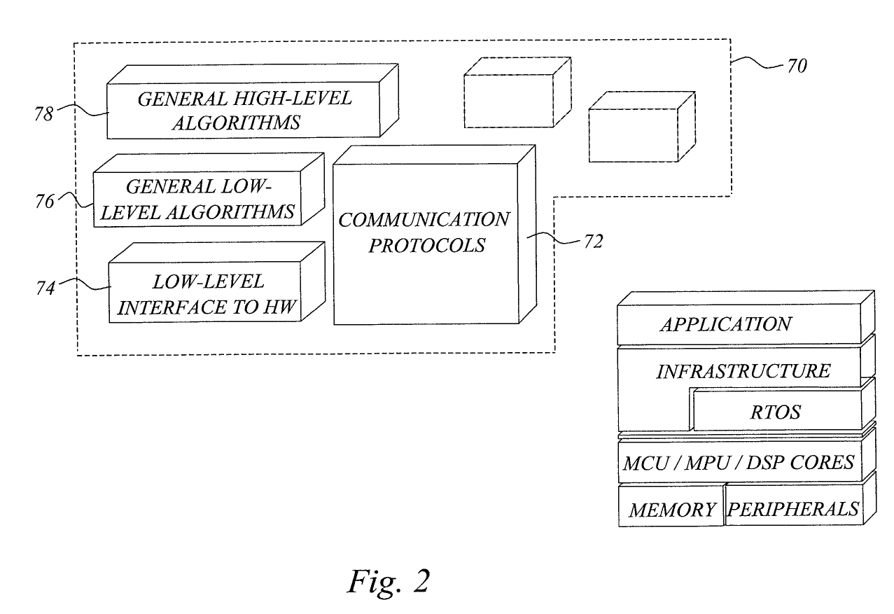

### DETAILED DESCRIPTION OF EMBODIMENTS OF THE INVENTION

Throughout the drawings, the same reference characters will be used for corresponding or similar elements.

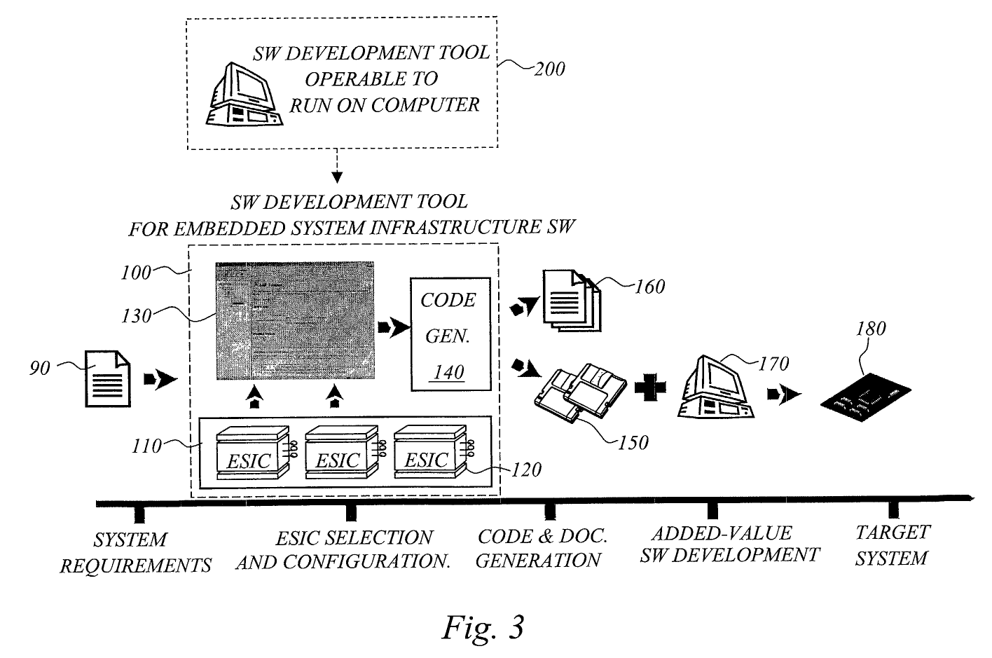

It will be useful to start with a general overview of the embedded system development technology proposed by the invention with reference to FIG. 3. Specific details of the system architecture, implementation, methods and algorithms that are employed will be described later on. The developer starts off with a set of system requirements 90 and utilizes the software development tool 100 for fast, efficient and flexible development of an embedded system software infrastructure 150. The software developer subsequently develops the application 170 on top of the generated software infrastructure, makes the necessary connections from the software infrastructure to the application and to target hardware, and finally compiles the entire software package for download to the target system 180.

The software development tool 100 basically comprises a repository 110 of pre-programmed software components or functional modules 120 called ESICs (Embedded System Infrastructure Component), a graphical user interface 130 and a code generator 140. The entire software development tool 100 is generally operable to run on a computer 200 equipped with a user interface. In operation, the software development tool is typically installed on a standard PC or similar computer workstation, either on a stand-alone computer or in a client-and-server application.

The principal workflow of developing an embedded system with the software development tool according to the invention will be outlined below:

The developer starts off by selecting, using the graphical user interface 130 or a special selection tool, which ESICs 120 to include into the current project from the repository 110. This selection is based on what type of functionality is needed and what ESICs that are available. The next step is to configure the ESICs to match the requirements of the target application. This configuration is preferably accomplished graphically via the graphical user interface 130 or a special configuration tool. Each ESIC 120 normally contains a large number of configuration options in order to provide a very fine-grained control over the resulting functionality, the internal implementation structure, interfaces and performance trade-offs. In this way, the configured ESICs will be optimally tuned to the specific embedded system being designed. For each configuration setting that is selected by the user, immediate feedback is preferably provided to the user about the effects of the selected setting. Effects in terms of resulting code size, execution speed, specific restrictions and performance trade-offs. Using this information, an optimal infrastructure can quickly be evaluated and the most suitable functions can be selected. This automatic expert guidance in conjunction with detailed reference documentation enables a novice to accomplish a work of a senior (expert) engineer. Once the necessary ESICs have been selected and configured to best suit the needs of the target application, the program source code 150 required to implement these software infrastructure functions in the desired embedded system is automatically generated (through the press of a button) by the code generator 140. At the same time, all necessary documentation 160 of the generated program modules may also be generated. Advantageously, this documentation 160 only reflects the generated code 150, i.e. it is adapted to the selected ESICs and corresponding configuration settings. What remains is for the developer to interconnect the selected ESICs, generating the appropriate glue code, make the final connection to the target hardware and to develop the value-added portion of the embedded system, the application. The developer only has to make the final connection 170 to the hardware and to the application, compile the combined ESIC and application source code and download the complete software package to the target system 180.

Although the main focus of the invention is to build a hardware-independent, non-operating-system software infrastructure for an embedded computer system, it should be understood that there is nothing that prevents other types of configurable software components, such as simple real-time operating system components, from being integrated into the software development tool.

In short, the software development tool of the invention is a software product that supports the translation of selected infrastructure functionality into actual source code that implements the embedded system software infrastructure. The basis of the development tool is the ESICs 120 stored in the ESIC repository 110. Each ESIC focuses on a certain type of infrastructure function, e.g. a database, a file system, a TCP/IP communication protocol stack or a web-server. Preferably, each ESIC is realized as a self-contained software component, i.e. it contains all necessary aspects of an infrastructure function required for design and the actual implementation and possibly also for documentation.

The main strength of an ESIC is its flexibility to adapt to the requirements of a specific application, regardless of what hardware, operating system, or legacy code is employed in the target system. This flexibility is given by different levels of configurability.

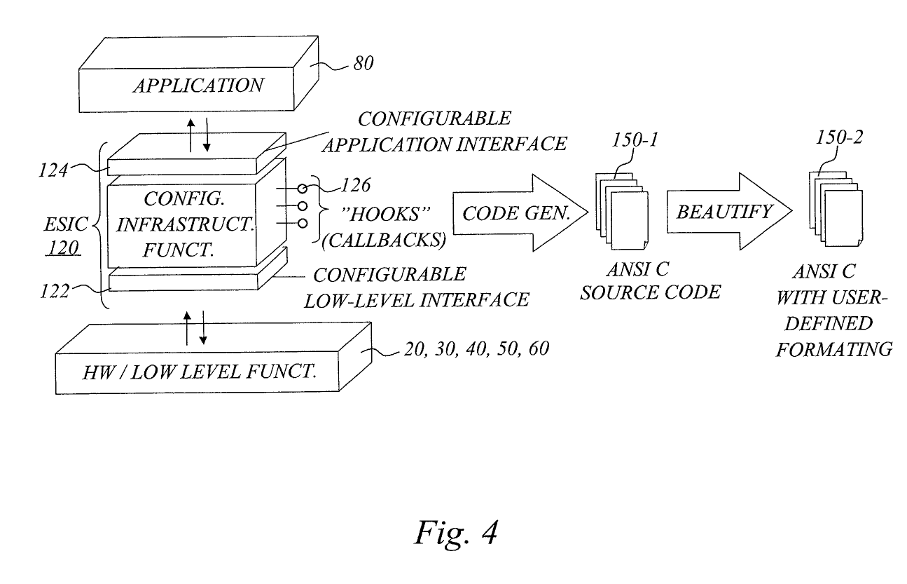

FIG. 4 illustrates different levels of ESIC configurability according to a preferred embodiment of the invention. First of all, the particular infrastructure functionality provided by an ESIC 120 can be configured to suit the needs of the relevant application. This typically means what sub-functions shall be included as well as what implementation shall be used for individual sub-functions, as will be detailed later on. Quite often a trade-off is made between execution speed and memory consumption.

As the ESIC code base is completely independent of target hardware or operating system, no hardware-specific commands or operating system commands are utilized in the code base. Instead, a highly configurable low-level interface is provided. There are normally many alternative ways of interfacing the lower system layers 20, 30, 40, 50, 60. There are many aspects that might vary depending on the selected system architecture of the target system. Therefore, each ESIC may be provided with a configurable low-level interface 122 that enables selection/configuration of interface aspects such as principal access mechanism, where and how interface data is stored, if and how data is passed between the layers, and so forth. Whenever the generated ESIC code needs to access the hardware or some operating system function, an interface function prototype is provided. The implementation of the interface function, however, is typically provided by the user.

In analogy with the configurable low-level interface 122, a configurable interface 124 towards the application layer may also be provided. The application interface 124 minimizes the integration work for the application programmer and developer, as the interface can be customized to match the system architecture of the application.

It is important to note that the developer generally has to make the final connection to the target hardware and application manually. However, since the interfaces 122, 124 can be configured to suit the target hardware and application, this work can be minimized.

To support horizontal integration and customization of the ESIC behavior, so-called “hooks” or callbacks 126 may be provided. Horizontal integration typically refers to the integration between ESICs and/or user code. The callbacks enable a user application or other user-defined function to temporarily interrupt the normal execution flow of the ESIC. These callbacks are called automatically during execution of the infrastructure functions, and enable application-specific processing. Callbacks are typically provided for functions where there are a great number of possible implementations from which a useful common implementational subset is difficult to extract.

Based on the configuration settings made by the developer, an optimized source code 150-1 is automatically generated. The resulting source code of an ESIC is preferably standard ANSI C source code. The invention also supports several “de-facto” programming styles, as well as user-defined styles and naming conventions. To support the application developer, the formatting of the ESIC source code 150-1 can thus be customized to match any customer-specific programming guidelines and coding standard to generate ANSI C with special formatting 150-2. This greatly improves the readability of the generated source code.

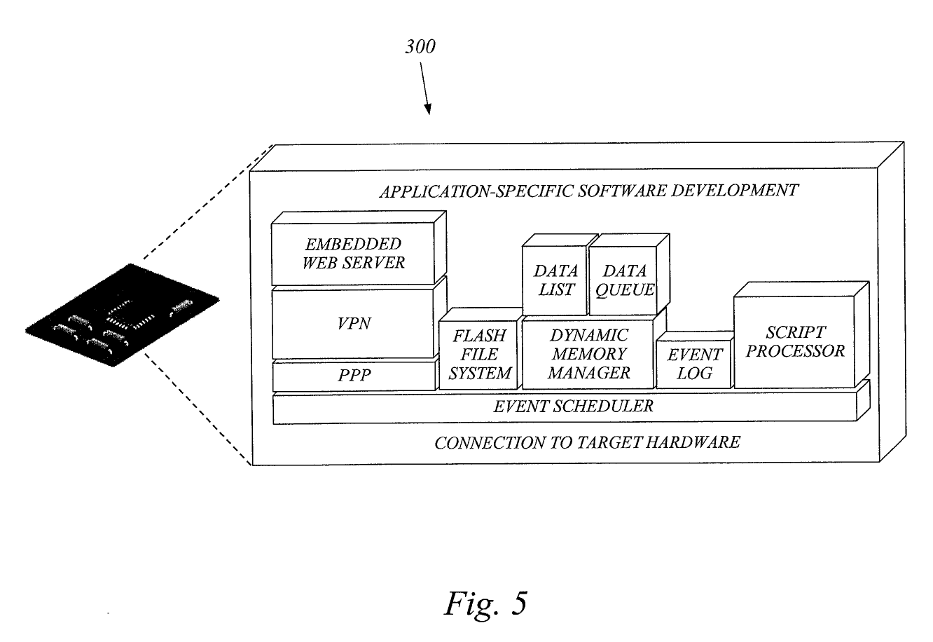

It may be useful to give an illustrative example concerning a wireless embedded data logger. For example, the application designer may have the following general system requirements on the data logger. The data logger should be able to sample a number of input channels simultaneously and store the result in an internal file system. The data logger is required to transfer the data at regular intervals to a central location over a GSM channel. It is also desirable that the data logger can be remotely configured and controlled via a web interface. The operation should be controlled through command scripts. In addition, a relatively high degree of security is required. The exemplary embedded system is resource constrained and equipped with a small memory and a low-capacity processor. As illustrated in FIG. 5, the embedded system software infrastructure for the data logger 300 is implemented by means of a Point-to-Point Protocol (PPP), a Virtual Private Network (VPN) protocol and an embedded web server, a flash file system, a dynamic memory manager and associated data structures, an event logger, a software-based script processor and an event scheduler. In view of the invention, the infrastructure functions are realized by selecting the corresponding ESICs that implement the required functions and configuring the selected ESICs according to the target application of the wireless data logger 300. The actual source code for the infrastructure software is automatically generated based on the configuration settings of the ESICs. The overall software package for the embedded data logger further comprises application-specific software as well as code for connection to the target hardware (GSM, FLASH, I/O). In a simple application like this using an event scheduler, there is generally no need for a real-time operating system.

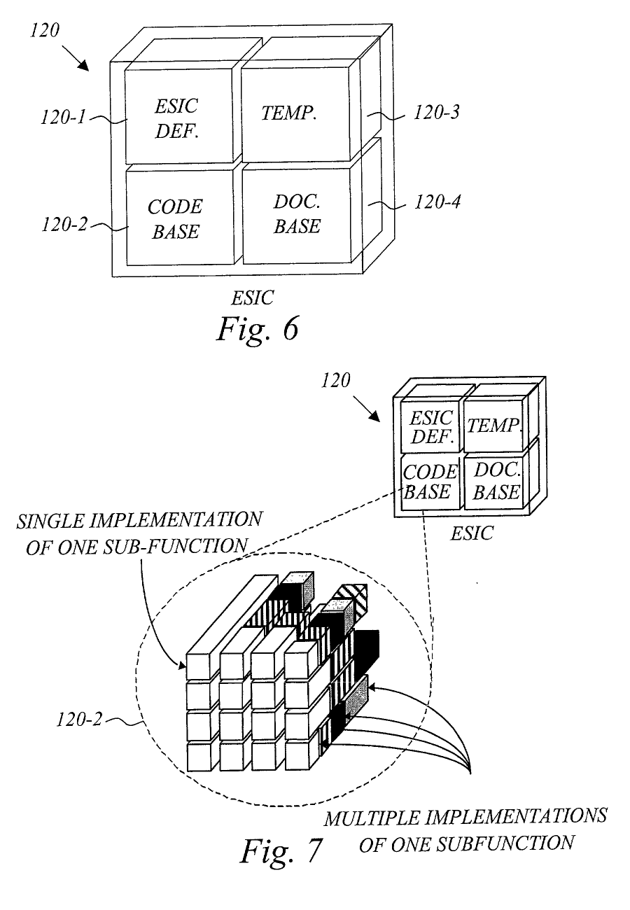

For a better understanding of the invention, the ESIC core will now be described in greater detail with reference to FIGS. 6-10.

FIG. 6 is a schematic diagram illustrating the principal building blocks of an ESIC according to an exemplary embodiment of the invention. An ESIC 120 generally holds all source code and information related to one specific infrastructure function, and is based on four principal building blocks: the ESIC definition 120-1, the ESIC code base 120-2, the ESIC templates 120-3 and the documentation base 120-4.

The ESIC definition 120-1 is preferably an XML document that describes all aspects of the ESIC. What configurations can be made, the effects of each configuration, reference documentation, etc. The actual content of the ESIC, however, is typically not contained in the ESIC definition. The ESIC definition rather includes basic information along with a configuration structure.

Advantageously, the actual code base 120-2 is highly modularized, which enables the code generation process to extract only the required functionality. This generally means that no unnecessary overhead due to generic implementations is incurred. The code generator extracts the relevant source code from the code base 120-2, based on the actual configuration of the ESIC. The code base 120-2 is preferably stored in a number of XML documents or similar files.

There are a great number of potential combinations of configurations, and in order to assist the user, a number of useful, standard configurations are preferably provided with each ESIC as templates 120-3. These templates provide suitable starting points when configuring an ESIC.

In similarity to the code base, all documentation associated with the generated source code is advantageously also stored in a number of XML files or similar document files. Based on the configuration of the ESIC, the correct documentation is generated by the code generator from this so-called documentation base 120-4.

The ESIC repository 110 (see FIG. 3) is normally a database of all known (although some of the ESICs may not be available to the user depending on the particular licensing agreement) ESICs in which each ESIC is viewed as a single file. By way of example, this file is an encrypted zip-file that may contain several versions of an ESIC; where each version consists of an ESIC definition 120-1, an ESIC code base 120-2, templates 120-3 and a documentation base 120-4.

As previously discussed, the infrastructure functionality provided by an ESIC can be configured to suit the requirements of a specific application. Fine-grained configurability of the infrastructure functions is provided through a modular code base with multiple implementations, as illustrated in FIG. 7. A specific function or algorithm often has many plausible implementations, with very different effects on code size, memory consumption and performance. For critical sub-functions, multiple implementations may therefore be provided by an ESIC to suit different application requirements. In order to maintain a highly portable code, only standard ANSI C code is utilized in the code base according to the currently most preferred embodiment of the invention.

The customization of an ESIC is accomplished by setting a number of configuration options for the ESIC. The system then generates all necessary source code required to implement the desired infrastructure function and maybe also the documentation.

The ESIC definition 120-1 describes the configuration structure of the ESIC, which is comprised of a set of configuration options or configurations. A configuration can be of different types, such as Boolean or numeric, defined by separate type elements. A configuration describes one customization possibility of the ESIC functionality. For each configuration, all permissible options are defined, i.e. what values the configuration can assume. For a Boolean type configuration, true or false are permissible values, while for a numeric configuration a value range would be defined. An option may be associated with a description of the consequences that particular option would have on the behavior of the ESIC. Configurations are typically used during the generation of configuration pages for the graphical configuration tool and by the code generation process. The validity of a configuration may be controlled by one or more requires elements. A configuration may contain sub-configurations.

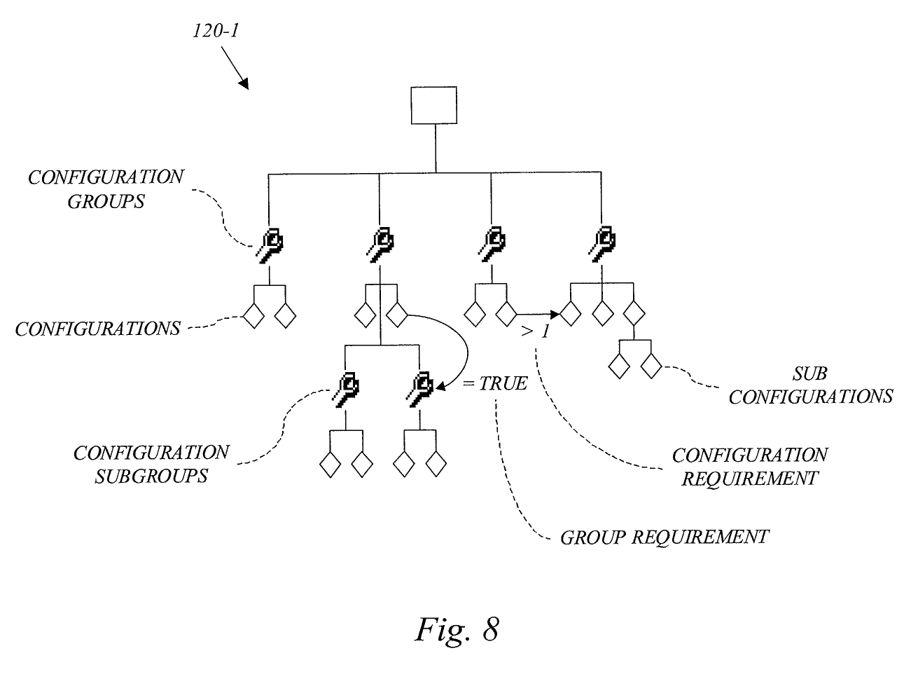

FIG. 8 illustrates an exemplary configuration structure of an ESIC including configurations, sub-configurations, groups, sub-groups and requirements. As can be seen from FIG. 8, the configurations of an ESIC may be organized into groups, where each group reflects a certain aspect of the ESIC. The group element defines one configuration group. A configuration group may consist of a mixture of configurations and sub-groups. A configuration, however, is always contained within a group. Configurations may also contain sub-configurations. Sub-configurations are configurations that are tightly linked to and usually dependent on a superior configuration. Not all configurations are valid at all times. Quite often one configuration is dependent on a combination of other configurations. For this purpose, a configuration may have a Boolean condition based on the current values of other configurations. If the conditions are not fulfilled, the configuration is invalid and not considered in the code generation. If a configuration is invalid, all of its underlying sub-configurations are invalid as well. Requirements can also be defined on configuration group level. If the condition of a group is not fulfilled, all of the underlying sub-groups and configurations are invalid.

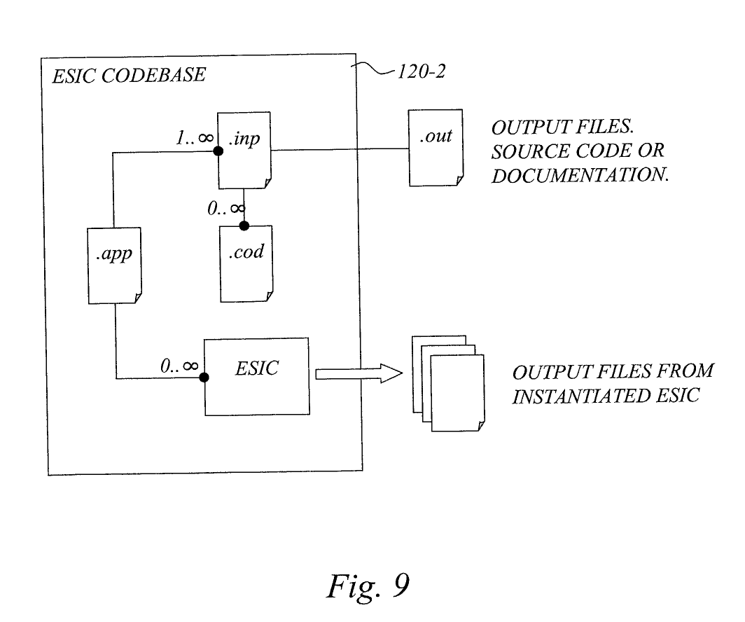

The code base 120-2 of an ESIC is preferably based on an application file (.app), one or more input files (.inp), zero or more code block files (.cod) and zero or more ESIC instantiations, as illustrated in FIG. 9. The application file is the main file in the code base and the starting point for the code generation. It specifies the output files (.out) to generate and the corresponding input files. Any instantiation of other ESICs is also specified in the application file. The code block files define re-usable code blocks that may be referenced. The input files include the mapping between ESIC configurations and ESIC code blocks to be generated. An output file (.out) is generated from an input file (.inp) in a sequential way, i.e. code defined in the beginning of the input file will be generated in the beginning of the output file. To simplify the structure of an input file it is possible to put code in code blocks that are referenced from the input file. There is generally a one-to-one relation between an input file and a generated output file, i.e. one input file will generate one and only one output file.

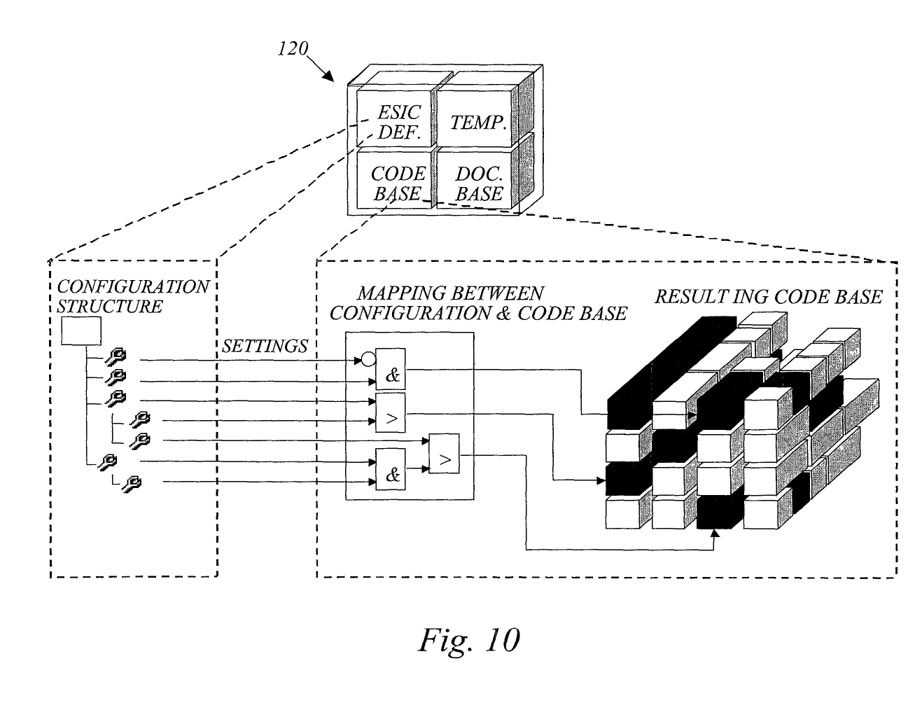

The mapping between the configurations of the ESIC and the code blocks that shall be used in the code generation process is preferably defined by the code base itself, as illustrated in FIG. 10. For each of a number of code blocks, a condition based on the configurations of the ESIC is defined. Based on the settings of the configurations, the relevant code blocks are extracted. Code blocks may also be parameterized by the configurations, thereby enabling reuse of common functionality. FIG. 10 only illustrates those parts of the mapping between configuration structure and code blocks that are related to the resulting source code.

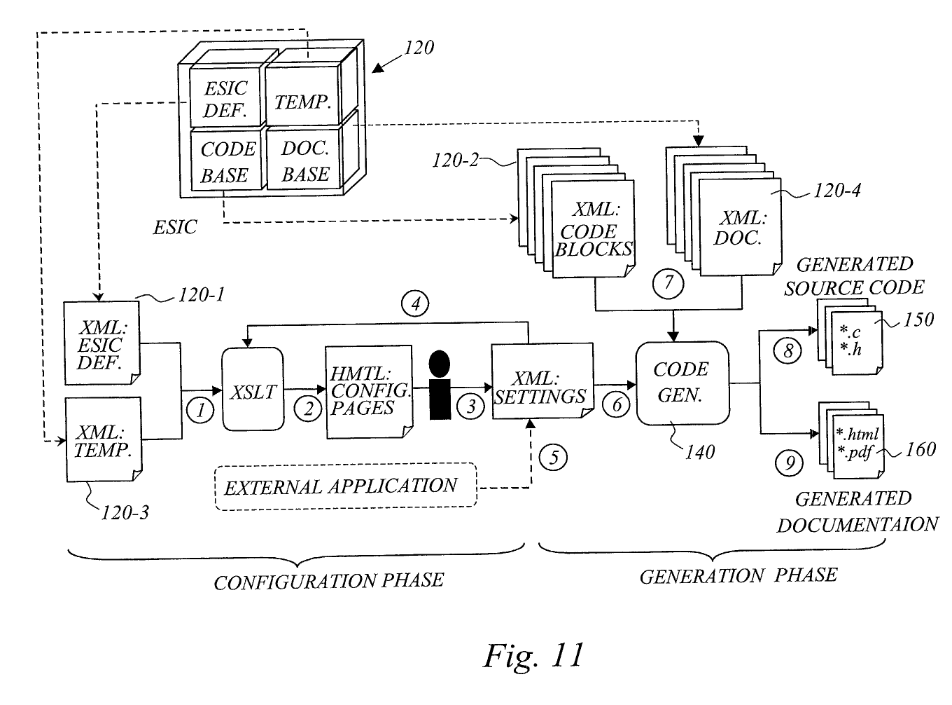

The ESIC configuration and code generation process according to an exemplary, preferred embodiment of the invention will now be described with reference to FIG. 11. During the configuration phase, a specific subset or permutation of the ESIC is selected. This phase is accomplished either by an end-user, or an application, and is based on the ESIC definition and templates. The actual target source code and documentation is generated during the generation phase, based on the configuration settings of the selected permutation of the ESIC.

1. In this particular example, the ESIC definition 120-1 together with a selected template 120-3 is processed by an XSLT (extensible Stylesheet Language Transformation) processor. The template specifies a specific subset or permutation of the ESIC, and acts a starting point for the configuration of the ESIC.

2. The XSLT processor transforms the XML-based ESIC definition 120-1 with its configuration structure into a number of configuration pages, e.g. in HTML (HyperText Markup Language) format, for presentation on the graphical user interface.

3. The user configures the ESIC instance via the generated configuration pages.

The resulting modified template permutation of the ESIC is stored in a separate XML document.

4. Since the available configuration options of an ESIC are dynamic, i.e. dependent on the configuration settings of the ESIC, the current settings of the ESIC are also used in the generation of the configuration pages.

5. Alternatively, the desired configuration could be provided by an external application.

6. Once the user is satisfied with the configuration, the ESIC settings are sent to the code generator.

7. The code generator 140 processes the code base 120-2 and documentation base 120-4 of the ESIC based on the settings.

8. The code generator then generates a set of ANSI C source code files 150 that implement the desired infrastructure function.

9. Preferably, the code generator also generates the documentation 160 associated with the target subset of the ESIC code base. The documentation may be generated in different formats such as HTML or PDF (Portable Document Format).

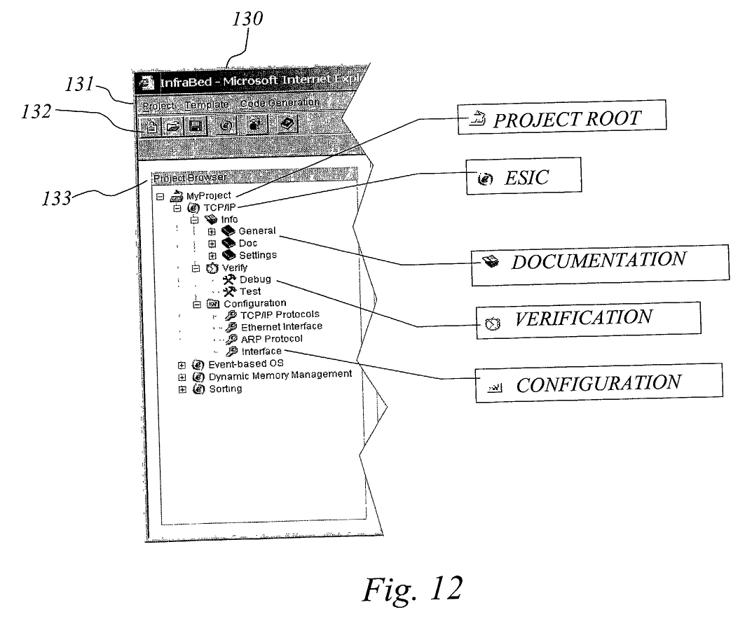

In order to get a more intuitive feeling of the software development process, an exemplary graphical user environment for starting a new embedded system software infrastructure project, adding ESICs to the project as well as configuring ESICs will now be described with reference to the screen displays shown in FIGS. 12-14.

FIG. 12 illustrates relevant parts of a screen display of the overall graphical user environment. The graphical user environment 130 includes menus 131, toolbars 132 and a project browser 133 as well as the actual project and information space (not shown in FIG. 12). The menus 131 are related to aspects such as project actions, templates and code generation. The toolbars 132 may include buttons for starting a new project, opening a previously stored project, saving a project, adding an ESIC to a project, generating code as well as a help button.

The project browser 133 makes it possible to browse through a project and perform quick actions. The project browser illustrated in FIG. 12 is based on a project root. From the project root, the current project settings including selected ESICs and ESIC settings can be viewed and changed in the project space. Under each ESIC, information related to documentation, verification and configuration of the ESIC can be found. The documentation part generally includes a general description, reference documentation and a description of the configuration options. The verification part includes a debug view showing debug-related configurations and as well as a test view. The configuration part holds the configuration structure including configuration groups, sub-groups and sub-configurations.

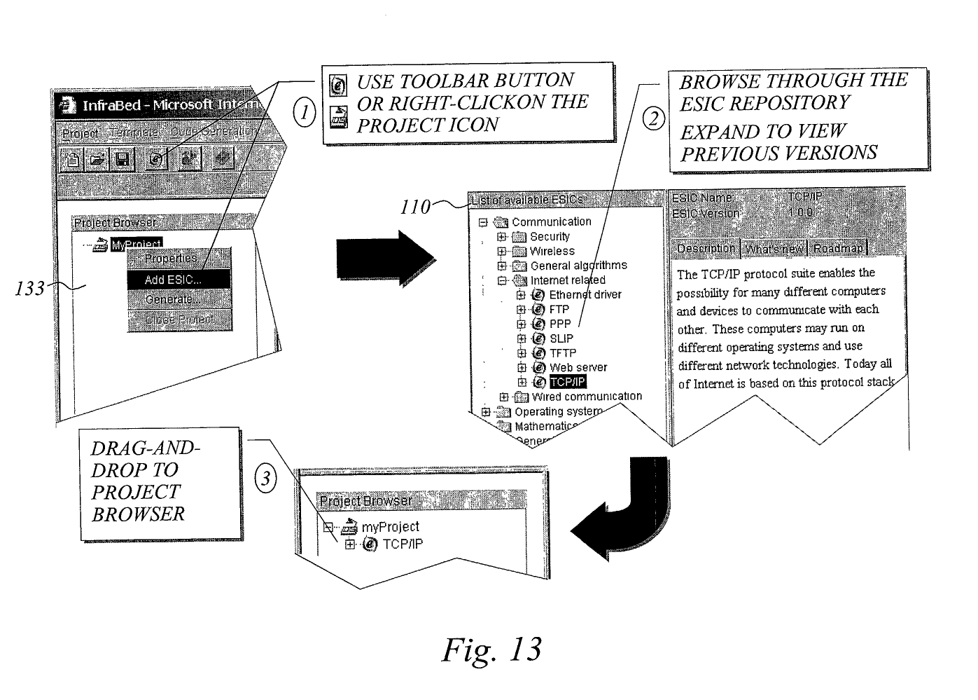

FIG. 13 illustrates relevant parts of screen displays used for adding an ESIC from the ESIC repository.

1. In order to add an ESIC to a project, it is possible to use the toolbar button “Add ESIC” or right-click the project icon in the project browser 133 and go down to “Add ESIC . . . ” on the pop-up menu thus presented.

2. Now, the ESIC repository 110 with a list of available ESICs will be presented. Browse through the repository and view information on the various ESICs. The ESICs are generally organized in folders and sub-folders, with ESICs with similar infrastructure functions being collected in the same folder.

3. In order to add an ESIC to the current project, just drag-and-drop the desired ESIC to the project browser.

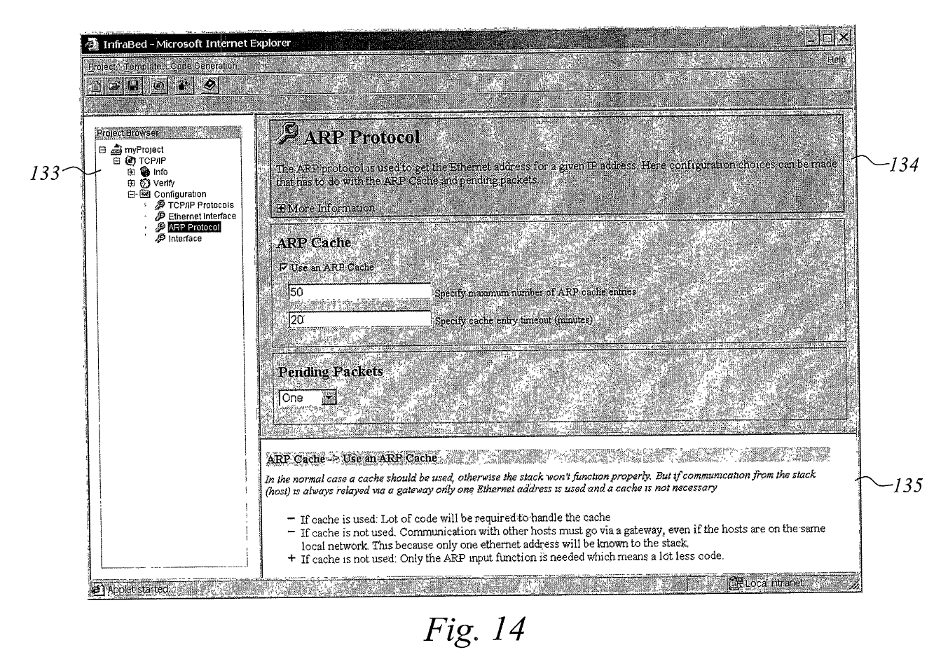

FIG. 14 illustrates the graphical user environment as a configuration page is displayed in the project space. By clicking on the desired configuration group, e.g. the ARP protocol (Address Resolution Protocol), under the TCP/IP ESIC in the project browser 133, the relevant configuration page will be displayed in the project space 134. The configuration page, which preferably is generated by an XSLT processor based on the XML file describing the configuration structure of the ESIC, comprises a general description of the ARP protocol, and a number of configurations. By pointing on a given configuration, a description of the basic function together with the consequences of the different options will be displayed in the information space 135 situated below the project space 134. If the ARP protocol has been selected, the first configuration relates to whether or not an ARP cache should be used. This is a Boolean configuration with only two options. If the check-box for using an ARP cache is marked, it is possible to further specify the maximum number of cache entries and the cache entry timeout period. These configurations are numeric configurations. Another configuration relates to the number of pending packets handled by the ARP protocol, and is a so-called single selection configuration.

In the following, ESIC interaction will be described. In general, the invention supports the combination and interaction of multiple ESICs to create composite infrastructure functions. The principal interaction methods between ESICs include interconnection of instantiated ESICs and encapsulation of one ESIC within another ESIC.

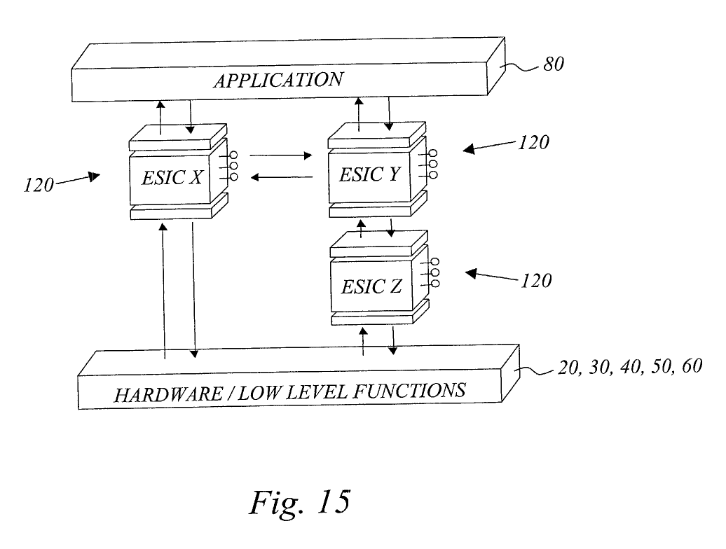

Two avoid compatibility problems, the general principle according to the invention is to keep the coupling between ESICs very loose. The interaction between two interconnected ESICs is generally managed via the interfaces exposed by each ESIC. FIG. 15 is a schematic diagram illustrating how several ESICs interact with each other. Horizontal interaction between two ESICs 120 such as ESIC X and ESIC Y could for example be realized by letting a callback of ESIC X interact with an interface of ESIC Y. Vertical interaction is normally handled via the low-level and application interfaces of the ESICs together with the necessary “glue code” to interconnect the ESICs. As illustrated in FIG. 15, there is no principal difference between the interaction of an ESIC 120 with a user application 80 or the hardware/low-levels function 20, 30, 40, 50, 60 of the embedded system, or between two ESICs 120 such as ESIC Y and ESIC Z. This means that the same amount of (manual) integration work is required to enable two ESICs to interact with each other. However, many ESICs will provide interface functions and callbacks specifically designed to work with other ESICs, thereby minimizing the application-specific integration work.

In order to provide the necessary “glue code” required to link two ESICs, the invention provides a connection function, preferably within its configuration tool. All the information required to generate the glue code, which enables two ESICs to communicate with each other, is stored in self-contained objects called ESIC Connections (EC). An EC thus describes which ESICs (and versions) that may be connected, which interfaces they utilize/support, and contains all of the necessary glue code and preferably also the documentation. An EC is thus similar to an ESIC, with the main difference that the configurations are described by the two ESICs not the EC. The EC thus describes the dependencies between ESIC configurations.

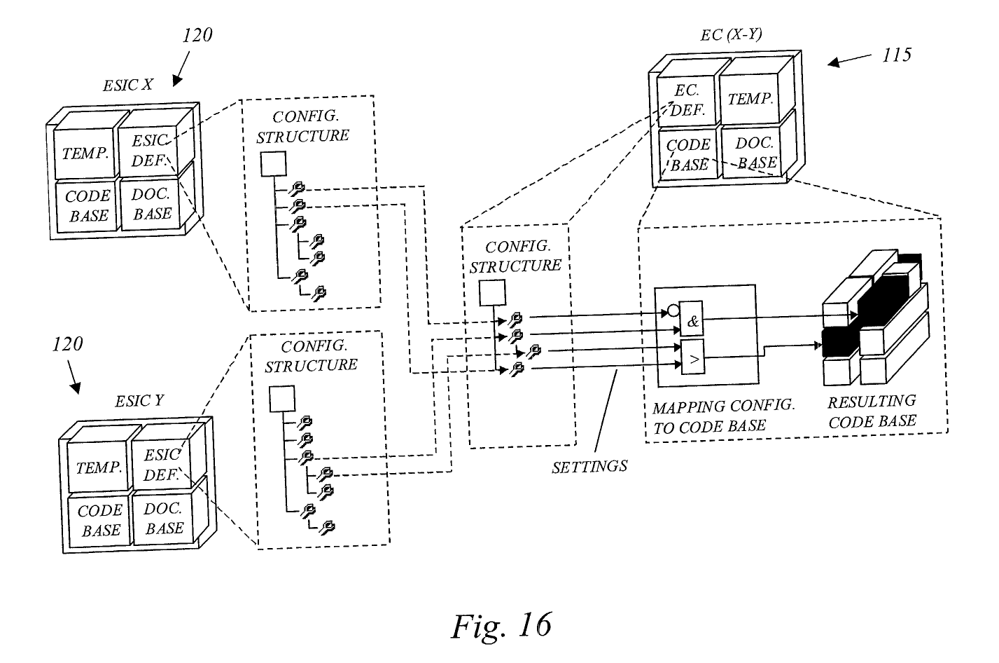

FIG. 16 illustrates the principal concept of generating glue code for interconnecting ESICs. Each one of the ESICs 120 (ESIC X and ESIC Y) to be interconnected has its own configuration structure in the ESIC definition. The EC 115 (EC X-Y) for interconnection of ESIC X and ESIC Y only specifies the dependencies between a configuration of ESIC X and a configuration of ESIC Y. The EC Configuration structure is thus a combination (and most often a subset) of the configurations of ESIC X and ESIC Y. Based on the settings of the configurations utilized by the EC, the corresponding source code is generated from the EC code base. The extraction of the resulting glue code from the EC code base is performed in the same manner as for ESICs, with a mapping between the EC configuration structure and the EC code base.

In the graphical user environment, all ESICs that have been instantiated into an project may be displayed on a “drawing board”, and a connection between two ESICs is preferably accomplished by simply clicking and “dragging” a link from one ESIC to another. If the connection is supported, a line is drawn between the two ESICs to indicate an existing connection. When a connection is being established, the selected interfaces (EC configurations) might not be valid. The system can then display the supported interfaces and query the user for a change, or automatically change the settings of the ESICs so that the interfaces are compatible (as specified by the EC). Once a connection has been established, certain configurations of the ESICs may be locked. This is to prevent that the user changes one interface, thereby creating an invalid connection. If the connection is not supported, a “stop” symbol is displayed when the mouse is positioned over the second ESIC (and no connection is established). The system may also notify the user why a connection could not be established, e.g. because the connection is not supported, the wrong version is used and so forth.

The second means of ESIC interaction is through encapsulation, i.e. the case when one ESIC (the outer ESIC) contains another ESIC (the inner ESIC). In simple terms, the inner ESIC is encapsulated by the outer ESIC by providing a reference to the inner ESIC in the outer ESIC and enabling configuration of the inner ESIC based on the configuration settings of the outer ESIC.

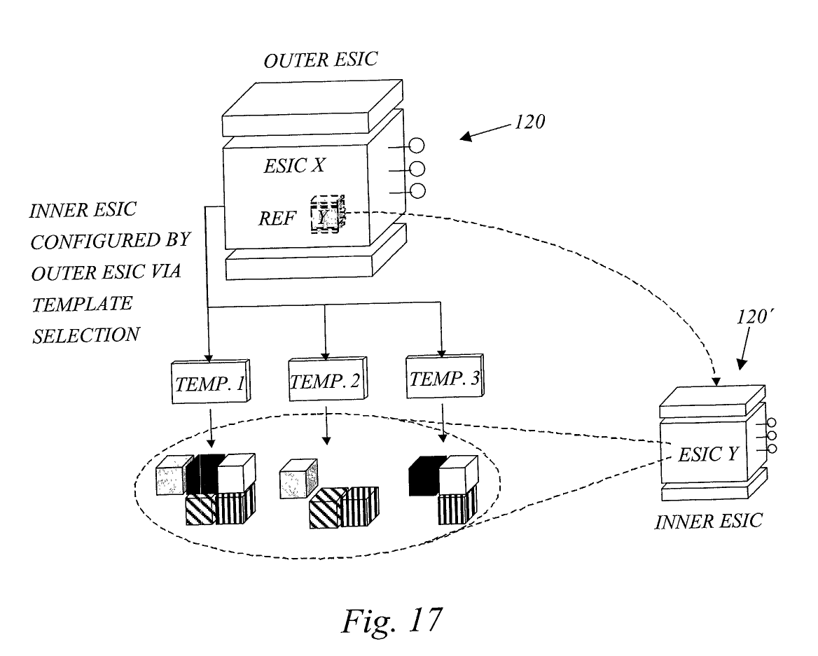

FIG. 17 illustrates an example of ESIC encapsulation. The outer ESIC 120 contains a reference REF to the inner ESIC 120′. Conveniently, none of the internal building blocks, such as the ESIC definition or code base, of the inner ESIC 120′ are actually contained in the outer ESIC 120. In fact, they are normally not even accessible by the outer ESIC 120. The inner ESIC is not visible from the outer ESIC. The inner ESIC 120′ is therefore not configured by an end-user, but rather by the outer ESIC 120. The configuration of an inner ESIC 120′ is preferably accomplished via one or more predetermined templates TEMP 1, TEMP 2 and TEMP 3. Based on the configuration of the outer ESIC, one of the templates is selected and applied to the inner ESIC. Through the use of templates, a consistent usage of the inner ESIC is assured, and compatibility problems are avoided.

Alternatively, or as a complement, configuration settings within a given template may be linked to configuration settings of the outer ESIC. In this way, a single template with a configuration that may vary in dependence on a configuration setting of the outer ESIC may replace a whole set of templates with different settings.

In general, compatibility problems can arise when an existing ESIC is upgraded. For this purpose all ESICs have a version number to uniquely identify the ESIC version. A three-digit version number is employed to handle various degrees of modifications:

Major Version: The major version number denotes an added functionality, and/or a changed interface of the ESIC.

Minor Version: The minor version number denotes changes in the implementation, minor changes in user interface or refinement of something existing.

Revision: The revision number denotes bug fixes. All templates and configuration choices are identical between revisions.

Typically, only ESICs with identical major and minor version numbers are compatible with each other. This also applies to template versions, to ensure that all settings specified in a template are valid. To apply a user-defined template with an incompatible version number, the template must first be converted. The conversion is preferably accomplished via XSLT stylesheets. Each ESIC contains a template conversion stylesheet that transforms a template from the previous version to the current version.

The invention also provides error reporting directly from the software development tool, where the current configuration is included and preferably also encrypted. This enables the support engineer to re-create the exact setup of the customer with respect to ESICs, version, actual configuration and so forth. This is preferably accomplished by generating, for at least one source code file generated by the code generator, a source code signature that represents the corresponding ESIC and the selected configuration settings. The complete ESIC set-up can then be re-created based on this source code signature. Preferably, each generated file has a header with a signature. The main purpose of the signature is to allow the developer to re-create the ESIC (and project) configuration as it was at the time when the file was generated. To simplify the process of re-creating an ESIC or an entire project, the invention may be provided with a wizard, which guides the developer through the necessary steps. The signature is secure because it does not reveal the ESIC configuration identifiers—only their values, and it does not reveal the values of the single selections—only the option's index. The ESIC XML is needed to make a complete recovery. In addition, the signature can also be encrypted before written to file to further increase the risk/possibility of de-compilation.

The encoding process is normally based on UTF-coding with various additions. This generally means that a string is converted into an UTF-8 encoded byte stream. Each byte in the stream is converted into a HEX value and then written as a two-character string. In a preferred embodiment of the invention, the following items are used in creating the signature:

The ESIC XML file;

The project file (XML);

The current template (XML);

The instance name of the ESIC (string);

An optional XSLT crypto (Java class).

The result of the encoding process is a string containing the signature. The following items are typically needed to re-create (import) an ESIC:

The signature (string);

The ESIC XML for the ESIC in the signature;

An open project;

The result of the decoding process (if successful) is an instance of the ESIC from the signature, in the current project. The ESIC will be configured in the same way as it was when the signature was generated. The properties of the project may or may not have been altered to comply with those in the signature, depending on the developer's choices in the Import ESIC wizard.

In order to verify that the source code file has not been tampered with, it is also possible to generate a source code checksum, using any conventional technique. The support engineer can then calculate the checksum of the re-created ESIC file and compare it to the original checksum to determine whether there is a checksum mismatch.

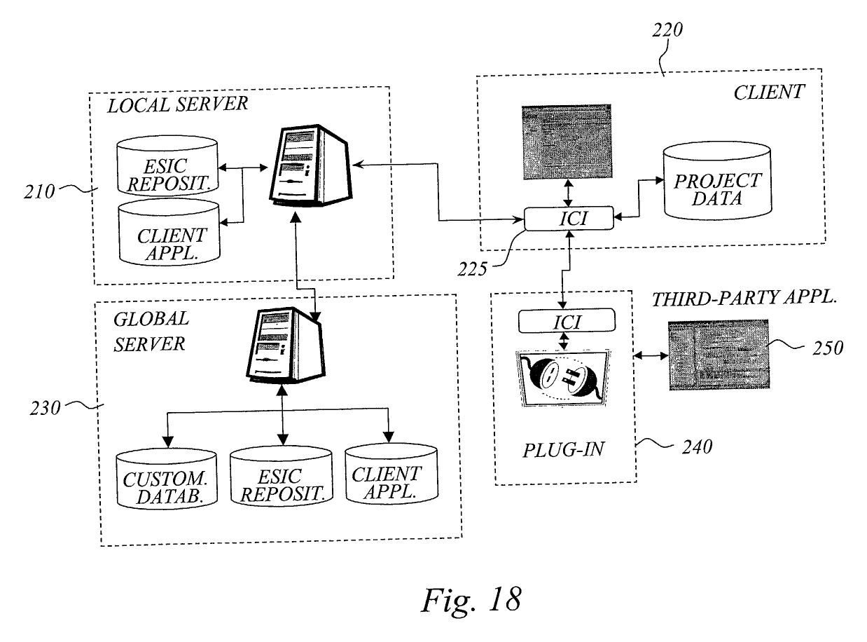

As previously discussed, the software development tool according to the invention may be installed for execution on a standard PC, either as a stand-alone computer or as a client-and-server application. The invention will now be described with reference to an exemplary client-and-server application. In this particular example, a distributed system architecture with a number of sub-systems is utilized. Each sub-system is responsible for a specific aspect of the invention, and all communication between sub-systems is accomplished via well-defined interfaces and protocols. FIG. 18 illustrates an example of the various sub-systems, and how they communicate with each other.

The local server 210 contains the code generator and manages the ESIC repository and client application data. This server 210 keeps a local database of all known ESICs. Upon request from the client, the local server retrieves ESICs from the database and sends the requested information to the client 220. All ESICs are packaged and encrypted on the server 220, but the data exchanged between the local server and a client is not necessarily encrypted. The ESIC repository of the local server 210 is typically kept up-to-date via ordinary CD-ROMs, DVDs or similar media, or alternatively via a connection to an optional global server 230. The local server 210 makes update requests to the global server 230 in order to retrieve information about new ESIC updates. If the server 210 has a valid license, the latest version may be downloaded. This means that an update request will update the ESIC list of the repository, but not necessarily download all new versions. The local server 210 also maintains all client application data, such as HTML pages, which are sent to the client upon request.

Preferably, the generation phase of the code generation process is managed completely by the local server 210. The client 220 sends a request for code generation of an ESIC along with its configurations.

The client 220 provides a graphical user environment to the end-user, where he/she can configure ESICs and initiate code generation. The core functionality of the client however, is provided by the client interface (ICI) 225. The client 220 merely provides a graphical representation.

The client interface (ICI) 225 is the API (Application Programming Interface) towards the local server 210 and the graphical user interface. As shown in FIG. 18, the ICI keeps track of all project specific data such as the instantiated ESICs and their current settings. In short, the ICI 225 provides the following base functionality:

The ICI provides all base functions for project handling, such as creating a new project, saving a project and so forth;

The ICI provides all functions required to instantiate and manipulate an ESIC from the repository; and

The ICI provides a standardized interface towards the code generation function of the local server.

The global server 230 contains the global ESIC repository, all available SW updates, as well as a customer database. The global server 230 generally has three main tasks:

All product updates are downloaded from the global server 230.

All ESIC updates are managed by the local server 210, which downloads the latest versions from the global server 230.

Bug reporting is managed by the local server 210, which sends problem and error reports to the global server 230. The global server also contains a customer database used for problem reporting feedback, and for authorizing update requests.

A plug-in 240 is a small application that interfaces a client with a third-party application 250, typically an IDE (Integrated Development Environment). The ICI provides all of the necessary callbacks to support the integration. A very typical integration between the client and an IDE is to transfer the generated code to the IDEs project workspace. The integration supported by a plug-in 240 is focused on file transfer, i.e. import/export of project settings, transfer of generated code, and so forth. The graphical configuration and generation is always managed by the client. If the third-party application 250 should handle the graphical configuration as well, it should be seen as a separate client.

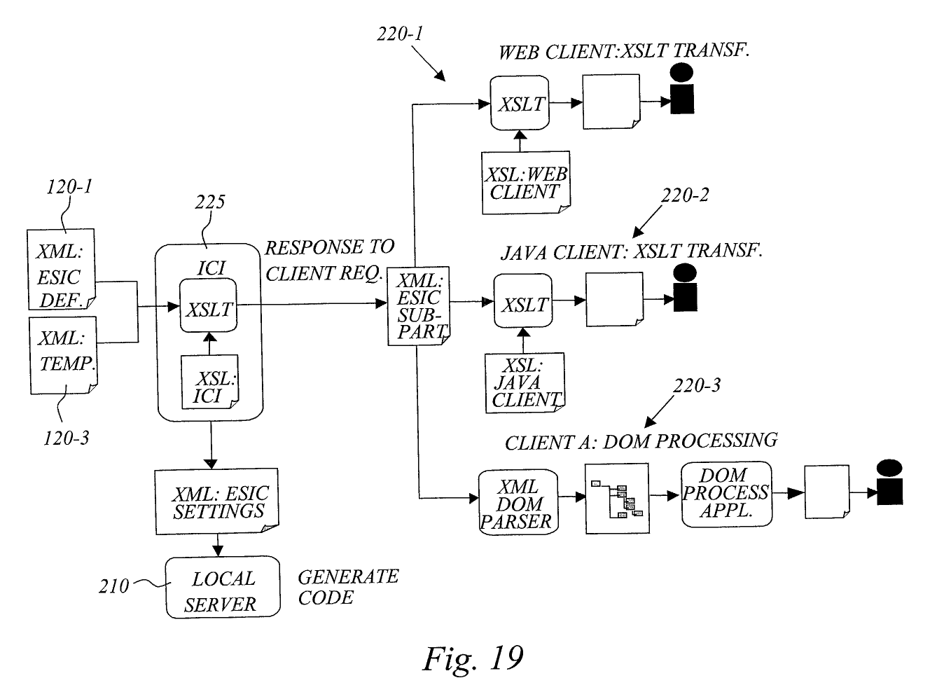

As illustrated in FIG. 19, the XML definition 120-1 and XML template 120-3 of an ESIC is processed by an XSLT processor in order to automatically generate the graphical configuration pages. The base processing is accomplished by the ICI 225, which provides subsets of the ESIC description to the client 220. The client 220 in turn processes the XML documents provided by the ICI 225 in order to generate the final configuration pages of the ESIC.

The client processing could also be based on XSLT. A web client 220-1 would generate HTML to visualize the configuration pages, whereas a Java client 220-2 would generate graphical Java components on-line. The only difference between the two client applications is the stylesheets used in the transformation process, as illustrated in FIG. 19.

However, depending on the graphical format of the client configuration pages, it might be necessary to utilize an XML parser and a non-XSLT transformation in the generation of the graphical configuration pages. If the XSLT processor is not able to generate the desired format, the DOM (Document Object Model) representation of the ESIC could be processed by the client 220-3.

All settings of the ESIC are maintained by the ICI 225, i.e. the client calls ICI functions to modify the configurations of an ESIC. Once the user has configured the ESIC, the code generation is initiated by the client 220 through the ICI 225. The code generation process starts when a client 220 issues a generate request for an ESIC. A configuration document with all settings for the specific ESIC is sent with the request to the local server 210 for code generation.

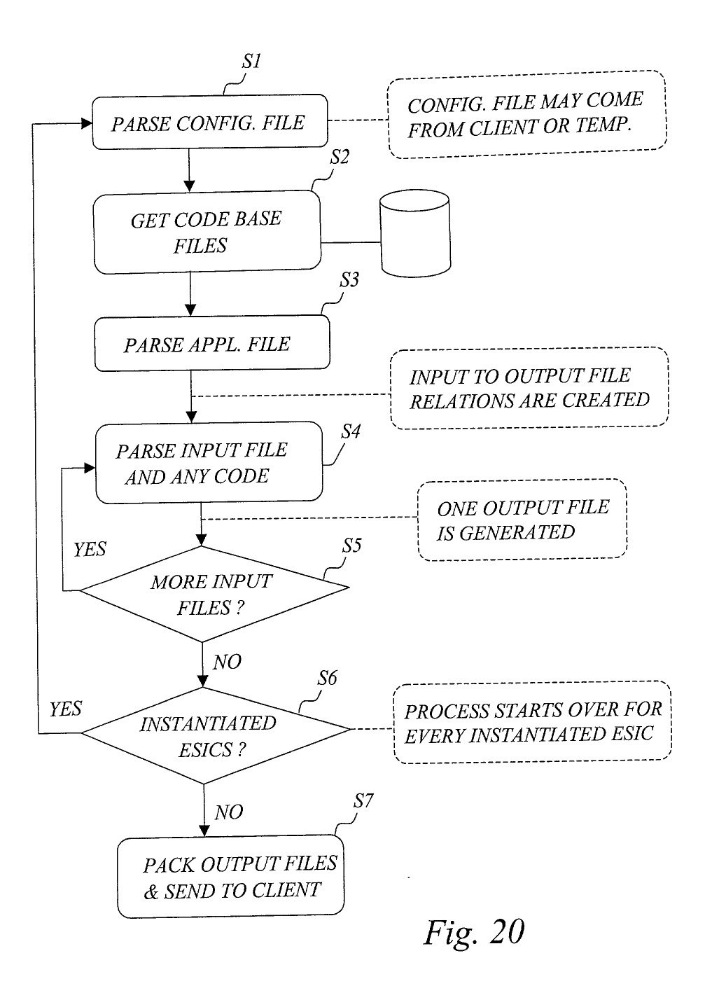

As illustrated in FIG. 20, the first step S1 in the generation process is parsing of the configuration file. This file typically comes from the client, or from a template if an instantiated ESIC is processed. The second step S2 is to decrypt and unpack all code base files for the specified ESIC. By decrypting and unpacking the required files at one time only, the performance will be improved since the code generator does not have to access to encrypted file every time a new code base file is processed. Next, in step S3, the application file is parsed and source file objects are created that hold information about the input file to output file mapping as well as any description that is supposed to be added to the output files. ESIC instantiations are also parsed and stored for later processing. In the next step S4, the input file and any referenced code blocks are parsed. When an input file is parsed, a corresponding output file is generated. Instantiated ESICs are parsed. Step S4 is repeated for all input files, until no more input files are present as detected in step S5. As indicated by step S6, the process S1-S5 starts over for every instantiated ESIC. Finally, in step S7, all generated output files are packed, e.g. in a zip-file, and sent to the client who made the request.

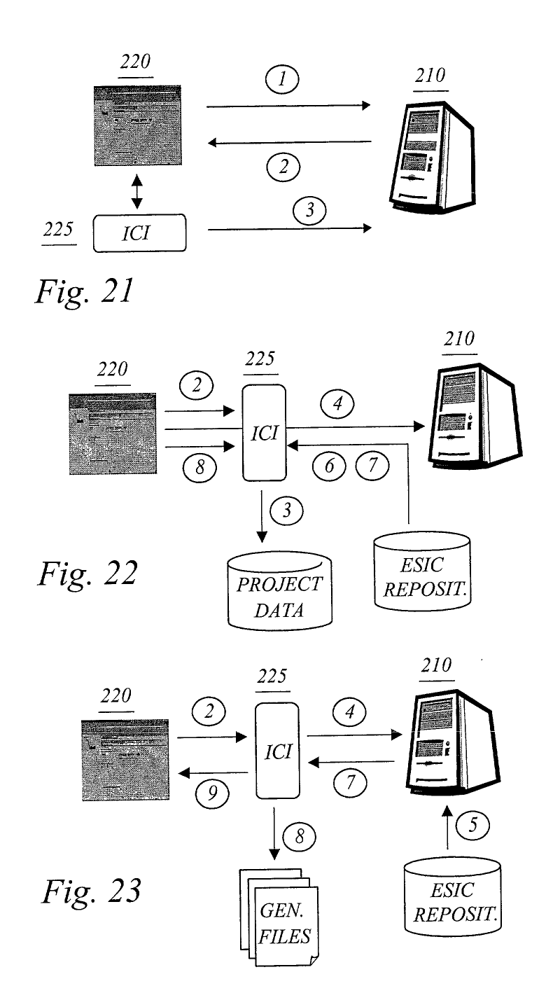

In the following, a number of basic use cases illustrating the interactions between the various modules of the client-and-server application will be described with reference to FIGS. 21-23. The local server 210 and ICI 225 are preferably implemented in Java, as well as the graphical components of the web client 220.

FIG. 21 illustrates how a user starts a web client 220.

1. The browser requests the start page.

2. The server 210 returns the start page, which loads all necessary applets.

3. The ICI layer 225 connects to the server 210.

FIG. 22 illustrates how a user creates a new project.

1. The user selects “create new project” from the menus or by using a toolbar button.

2. The client makes a “create project” request to the ICI 225.

3. The ICI 225 creates the necessary project files.

4. The client requests the list of available ESICs from server 210 via the ICI.

5. The user includes an ESIC to the project.

6. The ICI loads the ESIC description from the repository.

7. The ICI loads the default template of the ESIC.

8. The client requests the ESIC configuration structure for allowing display of suitable configuration pages in the project browser, thereby enabling user-configuration of the ESIC.

9. Repeat from 5, until the user has added all desired ESICs.

FIG. 23 illustrates how the user generates code.

1. The user selects “generate code” from the menus or by using a toolbar button.

2. The client 220 makes a “generate code” request to the ICI 225.

3. The ICI 225 validates and compiles all ESIC settings.

4. The ICI 225 sends the ESIC settings to the server 210.

5. The server 210 loads the code base of the ESIC and generates code based on the settings.

6. The server 210 packages and encrypts the generated files.

7. The server 210 returns the code package to the ICI 225.

8. The ICI 225 decrypts, extracts, and stores the generated files.

9. The ICI 225 sends a “new code available” notification to the client 220 and any other applications, e.g., a plug-in.

10. The client 220 displays status information about the generated files of the ESIC.

11. Repeat from 4 until all selected ESICs have been generated.

The embodiments described above are merely given as examples, and it should be understood that the present invention is not limited thereto. Further modifications, changes and improvements which retain the basic underlying principles disclosed and claimed herein are within the scope and spirit of the invention.

1. A software development tool for embedded computer systems, wherein said software development tool, which is operable to run on a computer equipped with a user interface, comprises:
a repository of configurable pre-programmed software components, called embedded system infrastructure components (ESICs), each of which is a self-contained object comprising an underlying modular code base and configuration structure related to a specific infrastructure function in a hardware-independent, non-operating-system software infrastructure for an embedded computer system;
a selection tool for enabling user selection of a number of ESICs from the repository;
a configuration tool for enabling user configuration, for each selected ESIC, of the corresponding infrastructure function based on the underlying configuration structure of the ESIC in order to match the requirements of a target application; and
a code generator for extracting, for each selected ESIC, source code for the embedded system software infrastructure as a subset of the modular code base of the ESIC based on the user-selected configuration settings.

2. The software development tool according to claim 1, further comprising means for enabling user-selected interconnection of a number of configured ESICs and wherein said code generator is operable for generating separate source code relating to the interconnection of the ESICs based on at least part of the configuration settings of the involved ESICs.

3. The software development tool according to claim 2, further comprising a number of configurable, pre-programmed ESIC connection components (ECs), each of which is a self-contained object comprising an underlying modular code base and a connection structure related to the interconnection of given ESICs, wherein said connection structure defines configuration dependencies between the configuration structures of the given ESICs, and said code generator is operable for extracting, for each user-selected EC, source code from the EC code base based on the ESIC configuration settings related to the connection structure of the EC.

4. The software development tool according to claim 1, wherein said configuration tool is operable for providing direct user feedback on the effects of a configuration setting in terms of at least one of resulting code size, execution speed, memory consumption, specific restrictions and performance trade-offs.

5. The software development tool according to claim 1, wherein at least one ESIC is provided with a first configurable interface towards underlying hardware/lower-level functions and a second configurable interface towards the target application, and said configuration tool is operable for enabling user configuration of said first hardware interface and said second application interface, and said code generator is operable for extracting source code for said interfaces based on the user-selected configuration settings of the interfaces.

6. The software development tool according to claim 1, wherein each ESIC further comprises a representation of the mapping between the configuration structure and the modular code base, and said code generator is operable for determining which parts of the modular code base to extract as source code based on the mapping representation in combination with user-selected configuration settings.

7. The software development tool according to claim 6, wherein said modular code base is defined by a number of code blocks, and said mapping representation comprises, for at least one of said code blocks, a condition for extraction as source code that is based on at least part of said configuration structure, and said code generator is operable for determining whether said condition is valid in response to the corresponding configuration settings.

8. The software development tool according to claim 1, wherein a first, so-called inner ESIC is encapsulated into a second, so-called outer ESIC by means of a reference to the inner ESIC in the outer ESIC, and said inner ESIC is configured based on the configuration settings of the outer ESIC.

9. The software development tool according to claim 8, wherein said inner ESIC is configured by said outer ESIC via template selection, said outer ESIC having a number of predetermined templates for configuring said inner ESIC and one of said templates being selected based on the configuration settings of the outer ESIC.

10. The software development tool according to claim 1, wherein at least one ESIC comprises, in the modular code base, code for multiple implementations of a given sub-function, and said configuration tool is operable for enabling user configuration of the infrastructure function of the ESIC with respect to the type of implementation to be used for the given sub-function.

11. The software development tool according to claim 1, wherein at least one ESIC has a callback that can be called during execution of the infrastructure function of the ESIC and enable temporary application-specific processing.

12. The software development tool according to claim 1, wherein each ESIC further comprises underlying documentation information, and said software development tool further comprises a documentation tool for generating, for each selected ESIC, documentation adapted to the selected configuration settings of the ESIC.

13. The software development tool according to claim 1, further comprising:
means for generating, for at least one source code file generated by the code generator, a source code signature representative of the corresponding ESIC and the user-selected configuration settings; and
means for re-creating the ESIC set-up based on the source code signature.

14. The software development tool according to claim 1, further comprising means for generating, for at least one source code file generated by the code generator, a source code checksum to enable verification that the source code file has not been tampered with.

15. The software development tool according to claim 1, wherein said configuration tool is operable for presenting a number of configuration options automatically based on the underlying configuration structure of the ESIC, and for receiving, via the user interface, user-selected configuration settings in response to the presented options.

16. The software development tool according to claim 15, wherein the configuration structure of an ESIC object is defined by means of an extensible description language and at least one configuration page with said configuration options is automatically generated from the extensible description language definition of the configuration structure by an extensible description language transformer.

17. The software development tool according to claim 16, wherein said extensible description language is XML (eXtensible Markup Language), said extensible description language transformer is an XSLT (eXtensible Stylesheet Language Transformation) processor, and said at least one configuration option page is provided in HTML (Hyper Text Markup Language) format.

18. The software development tool according to claim 1, wherein said software development tool is carried by a computer-readable medium.
